(19) United States
(12) Patent Application Publication
(10) Pub. No.: US 2007/0033847 A1
(43) Pub. Date: Feb. 15, 2007

(54) Display device

(75) Inventor: Yoshiyuki Tanaka, Suwa-gun (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/502,540

(22) Filed: Aug. 11, 2006

(30) Foreign Application Priority Data
Aug. 12, 2005 (JP) JP 2005-233976
May 10, 2006 (JP) JP-2006-131539

(51) Int. Cl. G09F 3/18

(52) U.S. Cl. 40/661.05

(57) ABSTRACT

[A display device] comprises a display panel 20 that is ring-shaped or can be formed into a ring shape and displays various kinds of information, a ring-shaped support member 12 that supports the display panel 20, a transparent member 11 that is ring-shaped and is disposed on the front side of the display panel 20 supported by the support member 12 so as to protect the display panel 20, and ring-shaped lid members 13 and 14 that mate with the support member 12 and hold the display panel 20 in conjunction with the support member 12 and the transparent member 11, the result of which is that the display panel is held in a sealed state.

### BACKGROUND OF THE INVENTION

1. Field to Which the Invention Belongs

The present invention relates to a display device, and more particularly relates to a display component holding structure in a display device that is ring-shaped.

2. Description of the Related Art

Various kinds of display device that can be attached to the body have been known in the past. One such display device that has been proposed is an electrophoretic display device that makes use of electrophoresis because of better power consumption, a thinner size, and other such considerations (see, for example, Japanese Laid-Open Patent Application H1-86116).

Electrophoresis is a known phenomenon by which charged particles dispersed in a liquid migrate when an electric field is applied.

With this kind of electrophoretic display device, an electrophoretic dispersion containing at least one type of electrophoretic particles (charged particles) is sealed between a pair of electrodes, voltage is applied between these electrodes, and an electric field is made to act on the electrophoretic dispersion, thereby effecting a display by changing the state of dispersion of the electrophoretic particles in the electrophoretic dispersion.

The above-mentioned conventional display device merely has the function of displaying the targeted information, and nothing more, and was therefore unsatisfactory in terms of functionality, such as being waterproof. Particularly in the case of a ring-shaped display device that is worn on the wrist, for example, nothing has been proposed that would be favorable as a structure for holding a display panel in a sealed state.

### SUMMARY OF THE INVENTION

In view of this, it is an object of the present invention to provide a display device with which a display panel can be held in a sealed state, in order to achieve waterproofness and other such functionality.

To solve the above problems, a first aspect of the present invention is [a display device] comprising a display component that is ring-shaped or can be formed into a ring shape and displays various kinds of information, a ring-shaped support member that supports the display component, a transparent member that is ring-shaped and is disposed on the front side of the display component supported by the support member so as to protect the display component, and a ring-shaped lid member that mates with the support member and holds the display component in conjunction with the support member and the transparent member.

With the above constitution, since the lid member is threaded to the support member and holds the display component in conjunction with the support member and the transparent member, the display panel (as the display component) can be held in a sealed state.

In this case, it is preferable if the lid member comprises a first lid member that is threaded to one end of the support member in the axial direction, and a second lid member that is threaded to the other end of the support member in the axial direction.

With the above constitution, since the first lid member and second lid member clamp the transparent member from both ends of the support member, the display panel can be held in a sealed state more securely, but with a simple structure.

Also, it is preferable if the lid member is threaded to one end of the support member in the axial direction, and the support member has a clamping component at the other end in the axial direction for clamping the transparent member in conjunction with the lid member.

With the above constitution, the lid member clamps the transparent member in being threaded to the end of the support member, and the display panel can be held in a sealed state more securely, even though few parts are entailed.

Also, it is preferable if the support member has a clamping component at one end in the axial direction, and the lid member has a mating component that is mated and fixed to the other end in the axial direction and clamps the transparent member in conjunction with the clamping component.

With the above constitution, the clamping component of the support member and the clamping component of the lid member are mated and fixed so as to clamp the transparent member, and the display panel can be held in a sealed state more securely, with a simple procedure.

Also, it is preferable if the support member has a screw receiver for receiving a screw, and the lid member has a screw hole, the screw is threaded into the screw receiver via the screw hole, and the mating component is mated so as to fix the lid member to the other end in the axial direction.

With the above constitution, the support member and the lid member are fixed by a screw in a mated state, and the display panel can be securely held in a sealed state.

Also, it is preferable if the screw receiver is provided perpendicular to the axial direction, and the screw hole is provided in the approximate center perpendicular to the axial direction.

With the above constitution, the support member and the lid member are fixed by a screw in a mated state, and the display panel can be reliably held in a sealed state, and furthermore the screw can be disposed in the approximate center perpendicular to the axial direction of the lid member, which affords greater design freedom.

Also, it is preferable if the support member has a latching component, the lid member has a flexible arm and an engagement component supported by the arm, and the arm is bent while the mating component of the lid member is press-fitted from the other end side of the support member, the engagement component is engaged with the latching component, the mating component is mated, and the lid member is fixed to the other end of the support member it the axial direction.

With the above constitution, the mating component of the lid member is press-fitted from the other end side of the support member while the arm is bent, the engagement component is engaged with the latching component of the support member, and the mating component is mated, thereby fixing the lid member to the other end of the support member in the axial direction, so the display panel (as the display component) can be securely held in a sealed state, with a simple operation.

Also, it is preferable if the mating component is mated by being press-fitted to one end of the support member in the axial direction.

With the above constitution, since the mating component of the lid member is mated by being press-fitted to the end of the support member, the display panel (as the display component) can be securely held in a sealed state, with a simple procedure.

Also, it is preferable if a sealing member is provided between the lid member and the support member, and another between the lid member and the transparent member, and the display component is held in a sealed state.

With the above constitution, the display component can be held in a sealed state more securely by the sealing member.

A second aspect of the present invention is [a display device] comprising a display component that is ring-shaped or can be formed into a ring shape and displays various kinds of information, a ring-shaped support member that is formed by a transparent member and in which is formed a holding groove with a ring-shaped cross section for holding the display component, and a ring-shaped lid member that is threaded to the support member and holds the display component in conjunction with the support member.

With the above constitution, the lid member is threaded to the support member and holds the display component in conjunction with the support member, so the display panel (as the display component) can be held in a sealed state.

Also, it is preferable if a sealing member is provided between the lid member and the support member, and the display component is held in a sealed state.

With the above constitution, the display panel (as the display component) can be held in a sealed state more securely by the sealing member.

### BRIEF DESCRIPTION OF THE DRAWINGS

FIG. 1 is an external oblique view of the display device in an embodiment;

FIG. 2 is a partial, end-slice oblique view of a display device, cut along the P plane shown in FIG. 1 and viewed in the A-A direction;

FIG. 3 is an exploded oblique view of a display device;

FIG. 4 is a simplified block diagram of the structure of a display panel;

FIG. 5 is a cross section of a display panel;

FIG. 6 is a detail cross section of a display panel;

FIG. 7 is a partial, end-slice oblique view of the display device of a second embodiment, cut along the P plane shown in FIG. 1 and viewed in the A-A direction;

FIG. 8 is a partial, end-slice oblique view of the display device of a third embodiment, cut along the P plane shown in FIG. 1 and viewed in the A-A direction;

FIG. 9 is an external oblique view of the display device in a fourth embodiment;

FIG. 10 is a partial, end-slice oblique view of a display device, cut along the Q plane shown in FIG. 9 and viewed in the A-A direction;

FIG. 11 is a cross section of the display device of a fifth embodiment;

FIG. 12 is an external oblique view of the display device in a sixth embodiment;

FIG. 13 is a cross section of the display device in the sixth embodiment;

FIG. 14 is a cross section of the display device in a seventh embodiment;

FIG. 15 is a cross sectional oblique view of the main components in the seventh embodiment;

FIG. 16 is a plan view illustrating the dimensional relationship of a latching component and engagement protrusions; and

FIG. 17 is a diagram illustrating the state of engagement between the latching component and the engagement protrusions.

### DESCRIPTION OF THE PREFERRED EMBODIMENTS

Preferred embodiments of the present invention will now be described through reference to the drawings.

The display device of the following embodiments is equipped with a display panel (display component) that is ring-shaped (or can be formed into a ring shape) and displays various kinds of information, and is designed so that when the display screen of the display panel is put inside a case made up of a lid member and a case body so as to allow the display screen to be seen from the outside, a sealing member ensures a tight seal during mating of the lid member and the case body.

This will now be described in more specific terms.

### (1) First Embodiment

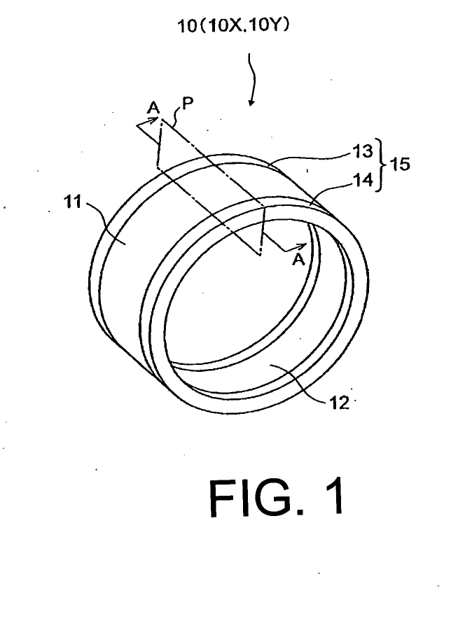

FIG. 1 is an external oblique view of the display device in an embodiment. A display device 10 broadly comprises a transparent member 11 formed in a circular cylindrical shape from a transparent material so that the display panel can be seen on the inside (discussed below), a circular cylindrical support member 12 that supports the display panel, and a lid member 15 having a first lid member 13 and second lid member 14 that clamp the transparent member 11 from the center axial direction of the support member 12. The transparent member 11 and support member 12 here form the case body.

The transparent member 11 is formed from glass or a hard plastic, and is formed in a circular cylindrical shape having a uniform thickness.

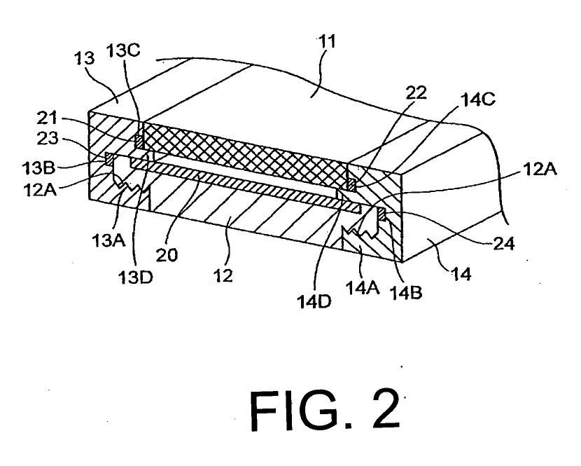

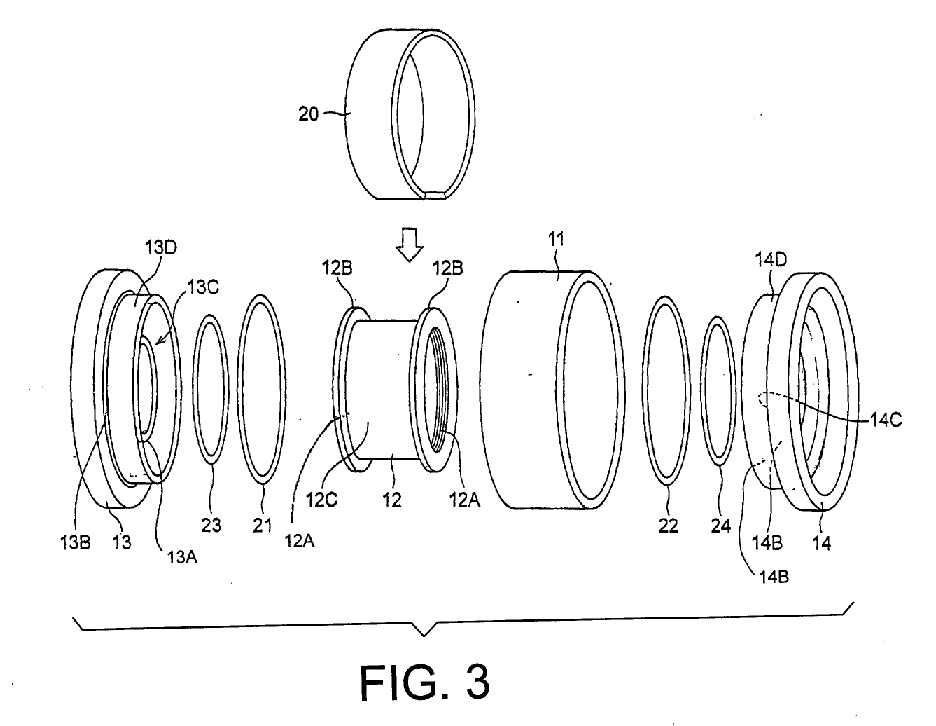

FIG. 2 is a partial, end-slice oblique view of a display device, cut along the P plane shown in FIG. 1 and viewed in the A-A direction. FIG. 3 is an exploded oblique view of a display device.

The first lid member 13 and the second lid member 14 have threads 13A and 14A, respectively, cut in the peripheral direction, and are threaded into threads 12A of the support member 12.

The support member 12 has flanges 12B formed on its peripheral faces, and a display panel 20 is fitted into a groove 12C formed by the flanges 12B. The transparent member 11 is clamped between the first lid member 13 and the second lid member 14 at a position across from the display panel 20.

In this case, a ring-shaped seal 21 is provided to ensure an airtight seal between the transparent member 11 and the first lid member 13. Similarly, a ring-shaped seal 22 is provided to ensure an airtight seal between the transparent member 11 and the second lid member 14. A ring-shaped seal 23 is provided to ensure an airtight seal between the support member 12 and the first lid member 13. Similarly, a ring-shaped seal 24 is provided to ensure an airtight seal between the support member 12 and the second lid member 14.

These seals 21 to 24 are formed from a synthetic resin or a resin containing rubber, and constitute sealing members.

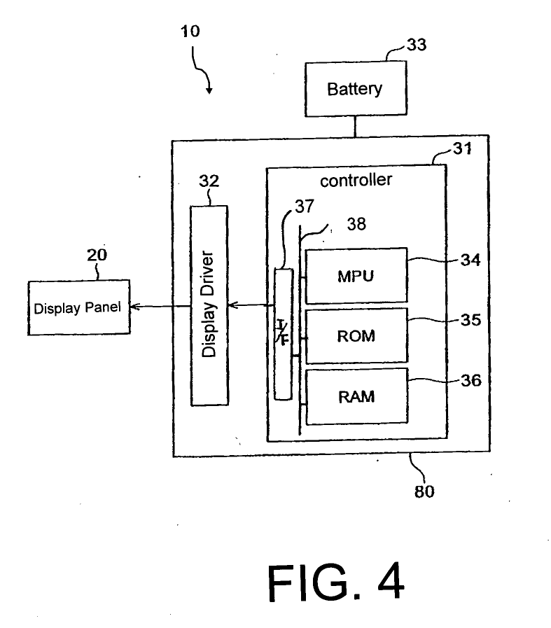

FIG. 4 is a simplified block diagram of the structure of a display panel. The display device 10 broadly comprises the above-mentioned display panel 20, a controller 31 for controlling the entire display device 10, a display driver 32 for driving the display panel 20 under the control of the controller 31, and a battery 33 for supplying power to the entire display device 10.

The controller 31 and display driver 32 here are formed over a control circuit substrate 80.

The controller 31 is constituted as a microcomputer, is equipped with an MPU 34 for controlling the entire controller 31, and in turn the entire display device 10, on the basis of a control program, a ROM 35 in which the control program is stored, a RAM 36 for temporarily storing various kinds of data, and an interface (IF) 37, and these are connected to each other by a bus 38.

The constitution of the display panel here will be described.

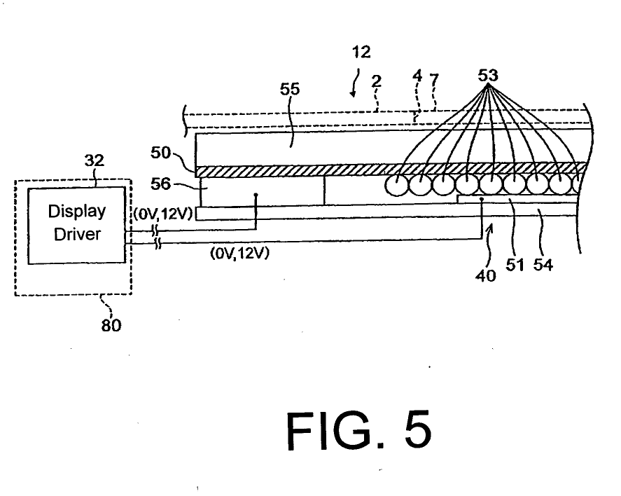

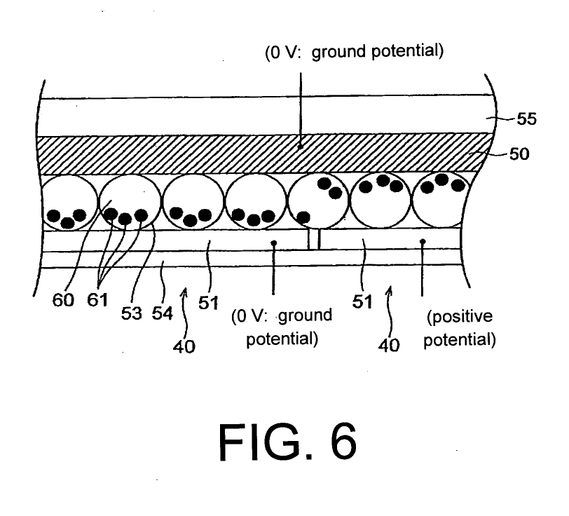

FIG. 5 is a cross section of a display panel. FIG. 6 is a detail cross section of a display panel.

In FIGS. 5 and 6, just a transparent electrode is hatched, and the other members are not hatched in order to avoid possible confusion in the drawings.

An electrophoretic display panel is used for the display panel 20. As shown in FIG. 5, the display panel 20 constituted as an electrophoretic display panel has a pair of electrodes consisting of a transparent common electrode 50 and a display control electrode 51, and a plurality of microcapsules 53 disposed sandwiched between the transparent common electrode 50 and the display control electrode 51.

The transparent common electrode 50 is a transparent electrode formed, for example, by the vapor deposition of ITO (indium-tin oxide) over a transparent glass substrate 55, and is disposed across from the display control electrode 51. This transparent common electrode 50 is constituted as a single electrode that spans the entire display control electrode 51, is connected to a common electrode 56 provided on a flexible substrate 54, and is thereby maintained at the same potential as this 56.

Also, the display control electrode 51 is an electrode provided at every segment (or dot) 40 of the display panel 20, and this display control electrode 51 is formed over the flexible substrate 54.

An electrophoretic dispersion liquid 60 (see FIG. 6) is sealed inside each of the microcapsules 53.

The display panel 20 constituted in this way is such that the display color exhibited by the microcapsules 53 can be seen through the glass substrate 55 and the transparent common electrode 50.

Drive voltage is supplied from the display driver 32 provided on the control circuit substrate 80 side, via electrical wiring provided (printed) on the flexible substrate 54, to the common electrode 56 and each of the display control electrodes 51, and an electric field is imparted to the electrophoretic dispersion 60 sealed inside the microcapsules 53. As shown in FIG. 4, blue particles 61 that have been colored blue are dispersed as electrophoretic particles in the electrophoretic dispersion inside the microcapsules 53 (this is known as a one-particle system). These blue particles 61 are charged to a positive polarity, and the electrophoretic dispersion 60 has been colored white.

Therefore, when the common electrode 56 is held at a voltage of 0 V (ground potential) so that the transparent common electrode 50 is at a 0 V potential, and drive voltage (positive voltage) is supplied to the display control electrodes 51 to produce a positive voltage, an electric field is generated from the display control electrodes 51 toward the transparent common electrode 50.

Consequently, as shown in FIG. 6, the positively charged blue particles 61 in the microcapsules 53 move to the transparent common electrode 50 side, and this is accompanied by movement of the white electrophoretic dispersion liquid 60 to the display control electrode 51 side.

As a result, because the microcapsules 53 exhibit a blue color, the segments 40 display blue.

Conversely, when drive voltage (positive voltage) is supplied to the common electrode 56 so that the transparent common electrode 50 is at a positive potential, and the display control electrodes 51 are held at a voltage of 0 V, the positively charged blue particles 61 move to the display control electrode 51 side, and this is accompanied by movement of the white electrophoretic dispersion 60 to the transparent common electrode 50 side.

As a result, the microcapsules 53 exhibit a white color, and the segments 40 display white. If no potential difference is produced between the transparent common electrode 50 and the display control electrodes 51, there will be no movement of the blue particles 61, so the display color of the segments 40 will not change, and will be kept in its previous state.

Thus, the display panel 20 displays various kinds of information in an information storage state (memory state).

Next, the assembly procedure for the display device will be described.

The seal 23 is fitted ahead of time to a sealing groove 13B of the first lid member 13, and the seal 21 is fitted to a sealing groove 13C. Similarly, the seal 24 is fitted ahead of time into a sealing groove 14B of the second lid member 14, and the seal 22 is fitted into a sealing groove 14C.

The display panel 20 is fitted ahead of time into the portion of the support member 12 defined by the flanges 12B.

Then, the support member 12 to which the display panel 20 has been fitted is put in the inside diameter portion of a guide protrusion 13D of the first lid member 13, and the threads 12A of the support member 12 are threaded onto the threads 13A of the first lid member 13.

In this state, the transparent member 11 is fitted over the outside diameter portion of the guide protrusion 13D of the first lid member 13.

The inside diameter portion of a guide protrusion 14D of the second lid member 14 is then put in the support member 12, and the threads 12A of the support member 12 are threaded onto the threads 14A of the second lid member 14 to complete the assembly.

The result of the above configuration is that the ring-shaped display device 10 is such that the display panel 20 can be put in a completely sealed state by the seals 21 to 24, and even though the configuration is simple, the display panel 20 can be securely held in a sealed state, and a waterproofing function and dustproofing function can be achieved with ease.

### (2) Second Embodiment

In the first embodiment above, the lid member 15 was constituted by two members, namely, the first lid member 13 and the second lid member 14, but in this second embodiment, the lid member is constituted by a single member.

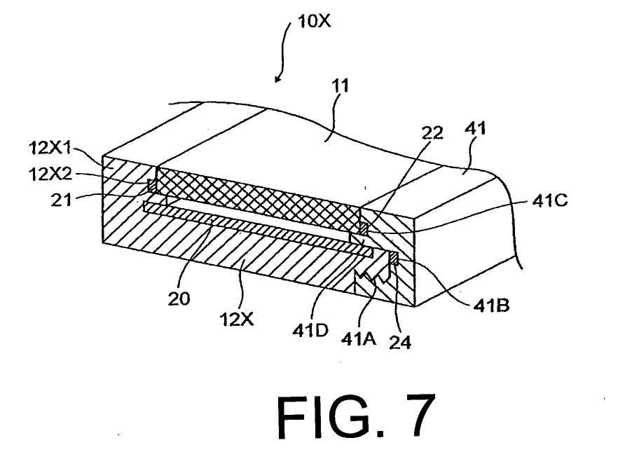

FIG. 7 is a partial, end-slice oblique view of the display device of the second embodiment, cut along the P plane shown in FIG. 1 and viewed in the A-A direction. In FIG. 7, those components that are the same as in FIG. 2 are numbered the same.

A lid member 41 of the second embodiment is threaded to one end of a support member 12X in the axial direction.

A clamping component 12X1 for clamping the transparent member 11 in conjunction with the lid member 41 is provided to the other end of the support member 12X in the axial direction. Here, the transparent member 11 and the support member 12X constitute the case body.

Next, the procedure for assembling the display device in the second embodiment will be described.

The seal 21 is fitted ahead of time into a seal groove 12X2 of the clamping component 12X1. Similarly, in the lid member 41, the seal 24 is fitted ahead of time into a seal groove 41B, and the seal 22 is fitted into a seal groove 41C.

The display panel 20 is fitted ahead of time into the support member 12X.

Then, the transparent member 11 is fitted into the support member 12X to which the display panel 20 has been fitted.

The inside diameter portion of a guide protrusion 41D of the lid member 41 is put in the support member 12X and threaded onto threads 41A to complete the assembly.

The result of the above configuration is that the ring-shaped display device 10X is such that the display panel 20 can be put in a completely sealed state by the seals 21, 22, and 24, and even though the configuration is simple, the display panel 20 can be securely held in a sealed state, and a waterproofing function and dustproofing function can be achieved with ease.

### (3) Third Embodiment

The transparent member was provided as a separate member in the first and second embodiments above, but in this third embodiment, the transparent member and the support member are constituted as a single member (namely, the case body).

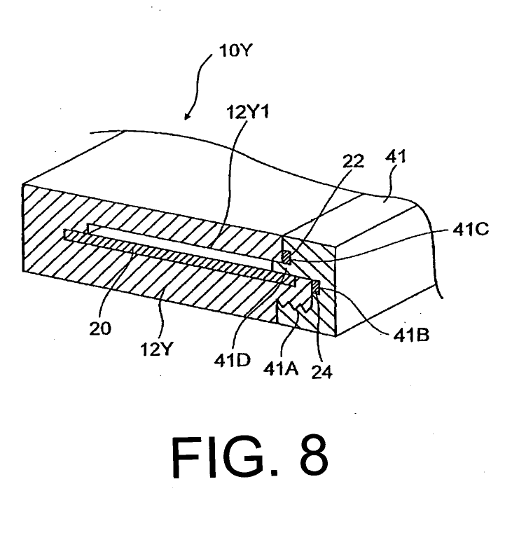

FIG. 8 is a partial, end-slice oblique view of the display device of the third embodiment, cut along the P plane shown in FIG. 1 and viewed in the A-A direction. In FIG. 8, those components that are the same as in FIG. 7 are numbered the same.

A support member 12Y in the third embodiment is formed from a transparent member, and a holding groove 12Y1 with a ring-shaped cross section and used for holding the display panel 20 is formed therein.

Next, the procedure for assembling the display device in the third embodiment will be described.

The display panel 20 is put ahead of time inside the holding groove 12Y1.

Meanwhile, in the lid member 41, the seal 24 is fitted ahead of time into the seal groove 41B, and the seal 22 is fitted into the seal groove 41C.

Then, the inside diameter portion of the guide protrusion 41D of the lid member 41 is threaded onto the support member 12Y in which the display panel 20 is held, to complete the assembly.

The result of the above configuration is that the display panel 20 can be put in a completely sealed state by the seals 22 and 24, and the ring-shaped display device 10Y is such that even though the configuration is simple and there are few parts, the display panel can be securely held in a sealed state, and a waterproofing function and dustproofing function can be achieved with ease.

### (4) Fourth Embodiment

The display device had a circular cross sectional shape in each of the above embodiments, but in this fourth embodiment, the cross section is substantially square in shape, the purpose of which is to increase the freedom of the cross sectional shape.

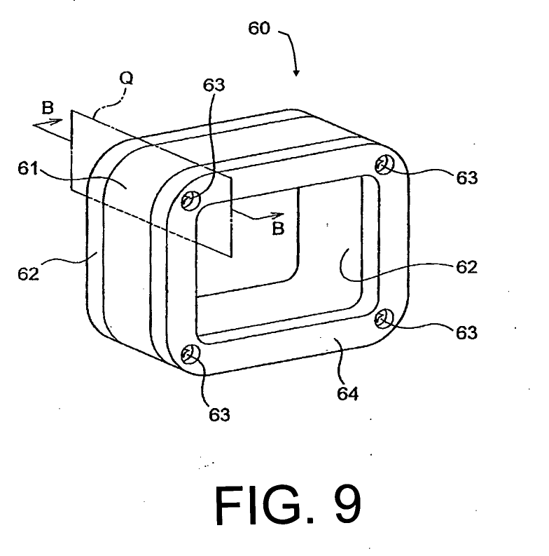

FIG. 9 is an external oblique view of the display device in the fourth embodiment.

A display device 60 broadly comprises a transparent member 61 formed in a substantially square cylindrical shape from a transparent material so that the display panel can be seen on the inside (discussed below), a substantially square cylindrical support member 62 that supports the display panel (discussed below), and a lid member 64 that is screwed to the support member 62 by a plurality of screws 63 and that clamps the transparent member 61 in conjunction with the support member 62. Here, the transparent member 61 and the support member 62 constitute the case body.

The transparent member 61 is formed from glass or a hard plastic, and is formed in a substantially square cylindrical shape having a uniform thickness.

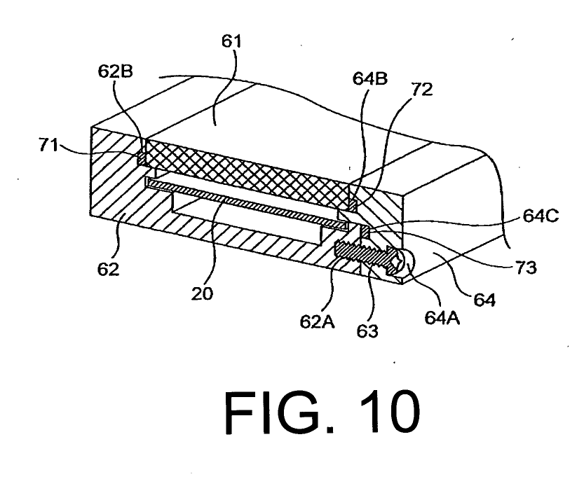

FIG. 10 is a partial, end-slice oblique view of a display device, cut along the Q plane shown in FIG. 9 and viewed in the A-A direction.

A screw hole 62A is provided to the support member 62, a screw hole 64A is provided in a corresponding location in the lid member 64, and screws 63 are threaded into a threaded groove constituting the screw hole 62A of the support member 62 and into a threaded groove constituting the screw hole 64A of the lid member 64, so that the display panel 20 and the transparent member 61 are clamped.

Next, the procedure for assembling the display device in the fourth embodiment will be described.

A seal 71 is fitted ahead of time into a seal groove 62B of the support member 62. Meanwhile, a seal 72 is fitted into a seal groove 64B of the lid member 64, and a seal 73 into a seal groove 64C.

These seals 71 to 73 are formed from a synthetic resin or a resin containing rubber, and constitute sealing members.

The display panel 20 is also fitted ahead of time into the support member 62.

Then, the transparent member 61 is fitted into the support member 62 to which the display panel 20 has been fitted.

The screws 63 are then threaded into the screw hole 64A of the lid member 64 and the screw hole 62A of the support member 62, thereby clamping the transparent member 61 and the display panel 20 in conjunction with the support member 62 and the lid member 64 and completing the assembly.

The result of the above configuration is that the display panel 20 can be put in a completely sealed state by the seals 71 to 73, and even though the configuration of the substantially square cylindrical display device 60 is simple, the display panel can be securely held in a sealed state, and a waterproofing function and dustproofing function can be achieved with ease.

### (5) Fifth Embodiment

In the fourth embodiment above, the position of the screw hole 64A was toward the inner peripheral face of the substantially square cylindrical display device 60, but in this fifth embodiment, there is greater freedom in the position where the screw hole is formed, which allows for a better aesthetic design.

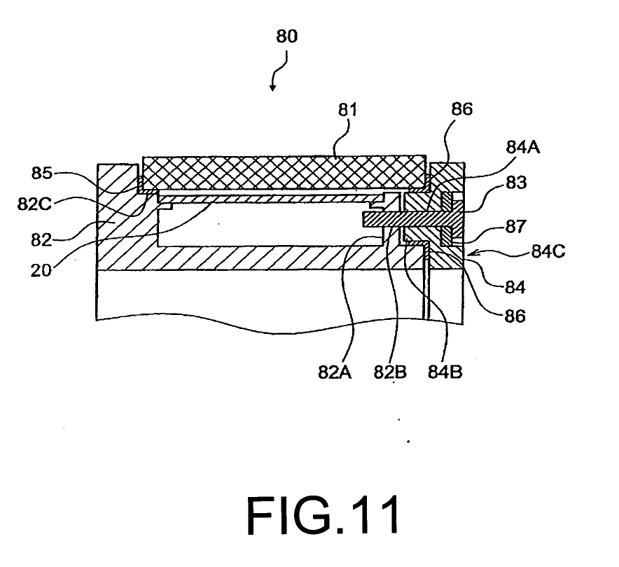

FIG. 11 is a cross section of the display device of the fifth embodiment.

A display device 80 broadly comprises a transparent member 81 formed in a substantially square cylindrical shape from a transparent material so that the display panel can be seen on the inside (discussed below), a substantially square cylindrical support member 82 that supports the display panel (discussed below), and a lid member 84 that is screwed to the support member 82 by a plurality of screws 83 and that clamps the transparent member 81 in conjunction with the support member 82. Here, the transparent member 81 and the support member 82 constitute the case body.

The transparent member 81 is formed from glass or a hard plastic, and is formed in a substantially square cylindrical shape having a uniform thickness.

Here, a screw receiver 82A is formed in the screw receiver 82A at a location across from the lid member 84, and a screw hole 82B is formed in this screw receiver 82A at a location across from a screw hole component 84B having a screw hole 84A protruding to the left of the lid member 84 in FIG. 11. As a result of these, the support member 82 and the lid member 84 are threaded together by the screws 83 and clamp the display panel 20 and the transparent member 81.

Next, the procedure for assembling the display device in the fifth embodiment will be described.

A seal 85 formed in a ring shape with an L-shaped cross section is fitted ahead of time into a seal receiver 82C of the support member 82. Meanwhile, a ring-shaped seal 86 is fitted ahead of time into the peripheral face of the screw hole component 84B of the lid member 84. A ring-shaped seal 87 is also fitted ahead of time to the screws 83.

Here, the seals 85 to 87 are formed from a synthetic resin or a resin containing rubber, and constitute sealing members.

First, the display panel 20 is fitted into the support member 82.

Then, the transparent member 81 is fitted into the support member 82 to which the display panel 20 has been fitted.

With the lid member 84 fitted into the support member 82, the screw 83 which has been fitted with the seal 87 is then threaded into the lid member 84 in the screw hole 84A.

After this, the screw 83 is threaded into the screw receiver 82A.

As a result of these, the support member 82 and the lid member 84 work in conjunction to clamp the transparent member 81 and the display panel 20, thereby completing the assembly.

The result of the above configuration is that the display panel 20 of the substantially square cylindrical display device 80 can be put in a sealed state by the seals 85, 86, and 87, so even though the configuration is simple, the display panel can be securely held in a sealed state, and a waterproofing function and dustproofing function can be achieved with ease.

### (6) Sixth Embodiment

In the fourth and fifth embodiments above, the support member and lid member were screwed together, but in this sixth embodiment, the support member and lid member are fixed by press-fitting.

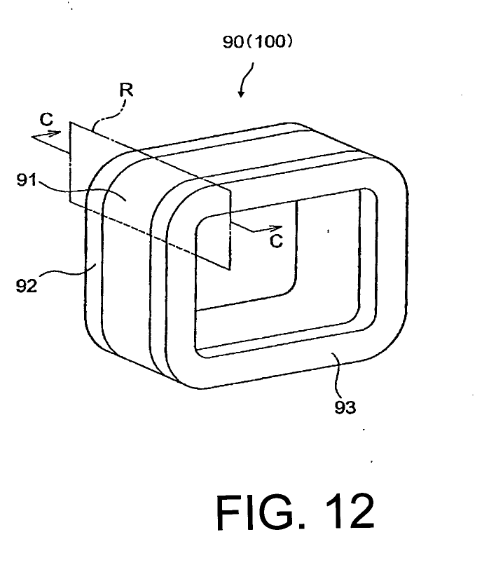

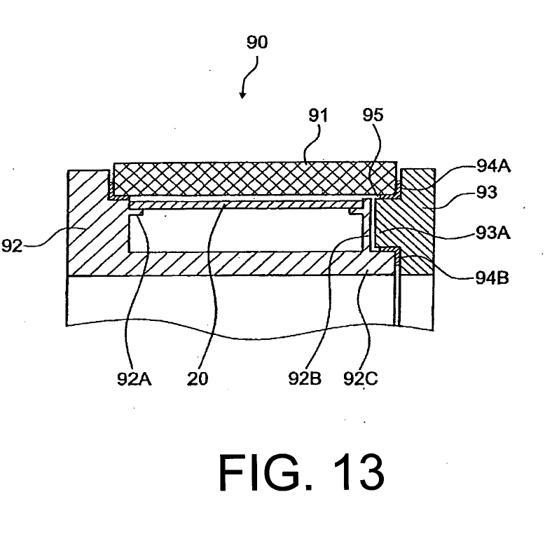

FIG. 12 is an external oblique view of the display device in the sixth embodiment, and FIG. 13 is a cross section of the display device in the sixth embodiment.

A display device 90 broadly comprises a transparent member 91 formed in a substantially square cylindrical shape from a transparent material so that the display panel can be seen on the inside (discussed below), a substantially square cylindrical support member 92 that supports the display panel (discussed below), and a lid member 93 that is fixed by being mated with the support member 92 and that clamps the transparent member 91 in conjunction with the support member 92.

The transparent member 91 is formed from glass or a hard plastic, and is formed in a substantially square cylindrical shape having a uniform thickness.

The support member 92 has a first support member 92A and second support member 92B for supporting the display panel 20, and a mating flange 92C to which the lid member 93 is mated.

The lid member 93 is provided with a ring-shaped mating protrusion (mating component) 93A, and a ring-shaped first seal 94A having an L-shaped cross section along this mating protrusion 93A is provided on the upper face side (in the drawing) of the mating protrusion 93A. Similarly, a ring-shaped second seal 94B having an L-shaped cross section along this mating protrusion 93A is provided on the lower face side (in the drawing) of the mating protrusion 93A.

Next, the procedure for assembling the display device in the sixth embodiment will be described.

The first seal 94A and second seal 94B are first fitted to the mating protrusion 93A of the lid member 93. Here, the first seal 94A and second seal 94B are formed from a synthetic resin or a resin containing rubber, and constitute sealing members.

The display panel 20 is placed on and fitted to the first support member 92A and second support member 92B of the support member 92.

Then, the ring-shaped transparent member 91 is fitted from the right (in the drawing) into the support member 92 to which the display panel 20 has been fitted.

In this state, the mating protrusion 93A of the lid member 93 is press-fitted and fixed inside a mating groove 95 formed by the mating flange 92C of the support member 92 and the transparent member 91, thereby clamping the transparent member 91 and the display panel 20 and completing the assembly.

The result of the above configuration is that the display panel 20 of the substantially square cylindrical display device 90 is put in a sealed state by the first seal 94A and second seal 94B, so even though the configuration is simple, the display panel can be securely held in a sealed state merely by press-fitting the mating protrusion 93A of the lid member 93 in the mating groove 95 formed by the mating flange 92C of the support member 92 and the transparent member 91, and a waterproofing function and dustproofing function can be achieved with ease.

### (7) Seventh Embodiment

In the sixth embodiment above, a configuration was employed in which the mating protrusion of the lid member was merely press-fitted in a mating flange formed by the support member and the transparent member, but in this seventh embodiment, in addition to press-fitting, the support member and the lid member are also fixed by being engaged.

The external appearance of the display device in this seventh embodiment is the same as that in the sixth embodiment shown in FIG. 12.

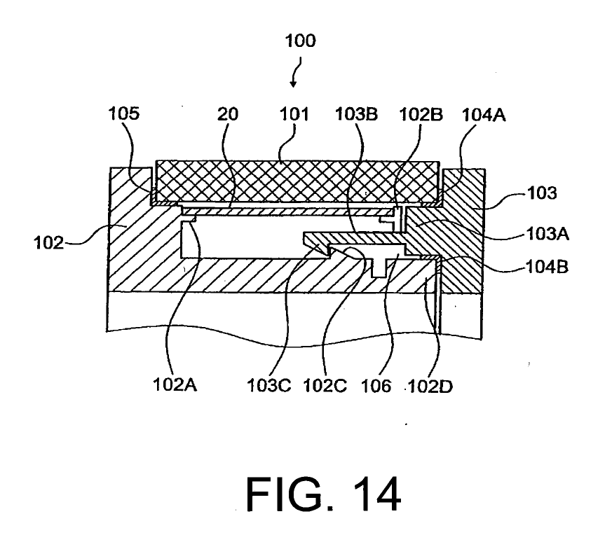

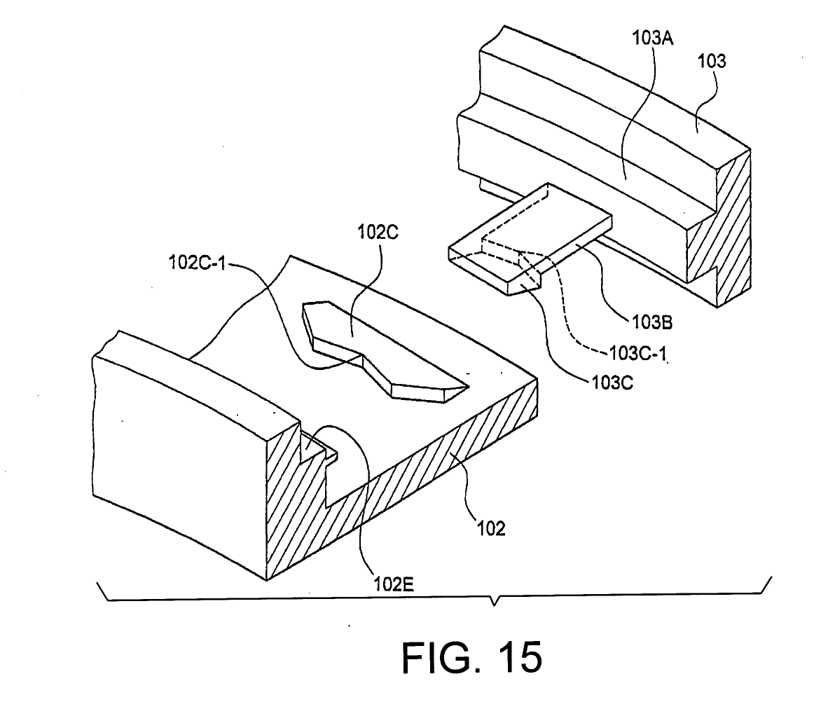

FIG. 14 is a cross section of the display device in the seventh embodiment, and FIG. 15 is a cross sectional oblique view of the main components in the seventh embodiment.

A display device 100 broadly comprises a transparent member 101 formed in a substantially square cylindrical shape (as seen from the outside) from a transparent material so that the display panel can be seen on the inside (discussed below), a substantially square cylindrical support member 102 that supports the display panel (discussed below), and a lid member 103 that is fixed by being mated to the support member 102 and that clamps the transparent member 101 in conjunction with the support member 102. Here, the transparent member 101 and the support member 102 constitute the case body.

The transparent member 101 is formed from glass or a hard plastic, and is formed in a substantially square cylindrical shape having a uniform thickness.

The support member 102 has a first support member 102A and second support member 102B for supporting the display panel 20, an engagement component 102C to which the lid member 103 is engaged, and a mating flange 102D to which the lid member 103 is mated. Also, a ring-shaped support member-side seal 105 having an L-shaped cross section is provided at one end of the support member 102.

The lid member 103 is provided with a ring-shaped mating protrusion (mating component) 103A, and a ring-shaped first seal 104A having an L-shaped cross section along this mating protrusion 103A is provided on the upper face side (in the drawing) of the mating protrusion 103A. Similarly, a ring-shaped second seal 104B having an L-shaped cross section along this mating protrusion 103A is provided on the lower face side (in the drawing) of the mating protrusion 103A.

Here, the first seal 104A and second seal 104B and the support member-side seal 105 are formed from a synthetic resin or a resin containing rubber, and constitute sealing members.

The lid member 103 has a flexible arm 103B and an engagement component 103C supported by this arm 103B. The arm 103B extends from the mating protrusion 103A.

The shape of the engagement component 102C and the mating protrusion 103A will now be described in detail.

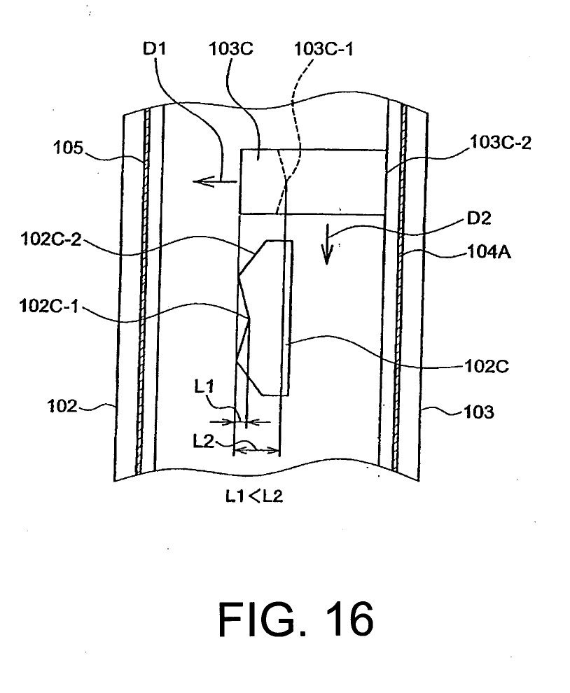

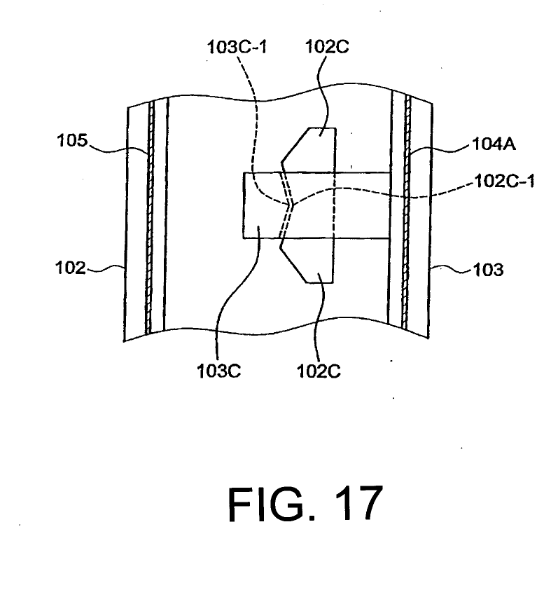

FIG. 16 is a plan view illustrating the dimensional relationship of a latching component and engagement protrusions, and FIG. 17 is a diagram illustrating the state of engagement between the latching component and the engagement protrusions.

When viewed from above, the engagement component 103C has a peaked roof shape that is convex on the mating protrusion 103A side, and the latching components 102C are formed in a concave shape in the mating protrusion 103A.

As shown in FIG. 16, when the arm 103B is inserted in the direction of the arrow D1 into the support member 102, without the arm 103B being engaged with the latching components 102C, and the lid member 103 has come into contact with the support member 102 via the first seal 104A and second seal 104B, the straight line distance L1 from the distal end of the arm 103B to the contact recess 102C-1 with which the tip 103C-1 of the engagement component 103C comes into contact in the course of engaging with the latching component 102C, and the length L2 from the distal end of the arm 103B to the tip 103C-1 of the engagement component 103C are in a relation of L1<L2, and as shown in FIG. 17, when the engagement component 103C is engaged with the latching component 102C, it is engaged while pushing down the first seal 104A and second seal 104B and the support member-side seal 105, which affords a more secure seal.

Next, the procedure for assembling the display device in the seventh embodiment will be described.

First, the first seal 104A and second seal 104B are fitted to the mating protrusion 103A of the lid member 103. Meanwhile, the support member-side seal 105 is fitted into a seal receiver 102E of the support member 102.

The display panel 20 is then placed on and fitted to the first support member 102A and second support member 102B of the support member 102.

Then, the ring-shaped transparent member 101 is fitted from the right (in FIG. 14) to the support member 102 to which the display panel 20 has been fitted.

In this state, the mating protrusion 103A of the lid member 103 is inserted in the direction of the arrow D2, in the state shown in FIG. 16, inside a mating groove 106 formed by the mating flange 102D of the support member 102 and the transparent member 101. The lid member 103 is then rotated in the direction of the arrow D2 so that the inclined contact face 103C-2 of the engagement component 103C hits the inclined contact face 102C-2 of the latching component 102C, and the lid member 103 is further rotated in the direction of the arrow D2.

As a result, the engagement component 103C and the latching component 102C of the support member 102 are slid while bending the arm 103B, so that the latching component 102C and the engagement component 103C are engaged, and the first seal 104A and second seal 104B and the support member-side seal 105 are pushed down while the support member 102 and the lid member 103 are mated, the transparent member 101 and the display panel 20 are clamped, and the assembly is completed.

The result of the above configuration is that the display panel 20 of the substantially square cylindrical display device 100 is put in a sealed state by the first seal 104A and second seal 104B and the support member-side seal 105, so even though the configuration is simple, the display panel can be securely held in a sealed state, and a waterproofing function and dustproofing function can be achieved with ease.

As described above, with the various embodiments, it is possible for the display panel to be securely held in a sealed state with a simple configuration, which means that a ring-shaped display device with an excellent waterproofing function, dustproofing function, and so forth can be achieved with ease.

The embodiments discussed above are nothing more than aspects of the present invention, and various modifications and applications are possible within the scope of the present invention.

The above description was of a case of using an electrophoretic display panel, but if it is a bendable display, then a liquid crystal display, electroluminescent display, or any of various other displays can also be applied.

Also, for example, the present invention is not limited to a constitution in which the electrophoretic dispersion 60 is sealed in the microcapsules 53, and the constitution may instead be such that each segment has a sealed structure, and the electrophoretic dispersion 60 is put into each segment.

Also, in the embodiments discussed above, a case of applying the display device pertaining to the present invention to the display component of an electronic device that is worn on the arm was given as an example, but as long as the display component is ring-shaped (circular cylindrical, square cylindrical, polyhedral cylindrical, etc.), the present invention can also be applied to the display component of other electronic devices, such as a PDA or portable telephone).

The above description was of a bracelet shape, but the present invention is applicable to any ring shape (circular cylindrical or square cylindrical), such as a necklace, a ring, a pendant, or articles of any of various other shapes.

The entire disclosure of Japanese Patent Application Nos: 2005-233976, filed Aug. 12, 2005 and 2006-131539, filed May 10, 2006 are expressly incorporated by reference herein.

What is claimed is:

1. A display device, comprising:
a display component that is ring-shaped or can be formed into a ring shape and displays various kinds of information;
a ring-shaped support member that supports the display component;
a transparent member that is ring-shaped and is disposed on the front side of the display component supported by the support member so as to protect the display component; and
a ring-shaped lid member that mates with the support member and holds the display component in conjunction with the support member and the transparent member.

2. The display device according to claim 1,
wherein the lid member comprises:
a first lid member that is threaded to one end of the support member in the axial direction; and
a second lid member that is threaded to the other end of the support member in the axial direction.

3. The display device according to claim 1,
wherein the lid member is threaded to one end of the support member in the axial direction, and
the support member has a clamping component at the other end in the axial direction for clamping the transparent member in conjunction with the lid member.

4. The display device according to claim 1,
wherein the support member has a clamping component at one end in the axial direction, and
the lid member has a mating component that is mated and fixed to the other end in the axial direction and clamps the transparent member in conjunction with the clamping component.

5. The display device according to claim 4,
wherein the support member has a screw receiver for receiving a screw, and
the lid member has a screw hole, the screw is threaded into the screw receiver via the screw hole, and the mating component is mated so as to fix the lid member to the other end in the axial direction.

6. The display device according to claim 5,
wherein the screw receiver is provided perpendicular to the axial direction, and
the screw hole is provided in the approximate center perpendicular to the axial direction.

7. The display device according to claim 4,
wherein the support member has a latching component,
the lid member has a flexible arm and an engagement component supported by the arm, and
the arm is bent while the mating component of the lid member is press-fitted from the other end side of the support member, the engagement component is engaged with the latching component, the mating component is mated, and the lid member is fixed to the other end of the support member it the axial direction.

8. The display device according to claim 4,
wherein the mating component is mated by being press-fitted to one end of the support member in the axial direction.

9. The display device according to claim 1,
wherein a sealing member is provided between the lid member and the support member, and another between the lid member and the transparent member, and
the display component is held in a sealed state.

10. A display device, comprising:
a display component that is ring-shaped or can be formed into a ring shape and displays various kinds of information;
a ring-shaped support member that is formed by a transparent member and in which is formed a holding groove with a ring-shaped cross section for holding the display component; and
a ring-shaped lid member that is threaded to the support member and holds the display component in conjunction with the support member.

11. The display device according to claim 10,
wherein a sealing member is provided between the lid member and the support member, and
the display component is held in a sealed state.
